(19) United States
(12) Patent Application Publication
(10) Pub. No.: US 2015/0286971 A1
(43) Pub. Date: Oct. 8, 2015

(54) BIT PERFORMANCE ANALYSIS

(71) Applicant: Saudi Arabian Oil Company, Dhahran (SA)

(72) Inventors: William B. Contreras Otalvora, Dhahran (SA); Murtadha M. Hubail, Qatif (SA); Ramzi S. Al-Ghamdi, Dammam (SA); Mohammed A. Hazzazi, Dammam (SA)

(73) Assignee: Saudi Arabian Oil Company, Dhahran (SA)

(21) Appl. No.: 14/244,062

(22) Filed: Apr. 3, 2014

(51) Int. Cl. G06Q 10/06

(52) U.S. Cl. CPC G06Q 10/0639

(57) ABSTRACT

The performance of drill bits proposed for use in drilling wells is analyzed for comparison and evaluation based on field experience, projected drilling and formation conditions, and performance criteria. Drill bits of different types and from different possible sources are analyzed with a common processing methodology to provide cost per foot data based on several possible drilling criteria contemplated for a well. The present invention also incorporates historical data from other wells and from similar formations to those of the planned well, as well as performance in similar conditions of the types of drill bits contemplated, and projected drilling strategies and trajectories.

### BACKGROUND OF THE INVENTION

1. Field of the Invention

The present invention relates to analysis of the performance of drill bits being evaluated for use in drilling wells for comparison and evaluation based on field experience, projected drilling and formation conditions, and performance criteria.

2. Description of the Related Art

In preparation for drilling a well for hydrocarbons from one or more layers of a subsurface reservoir, considerable effort, expense and planning is required. The objective of well planning is a well that can be drilled safely, economically, and practically. However, there are a very large number of factors or variables which must be taken into account in planning a well. Unfortunately, it is also not always possible to accomplish all objectives on each well plan because of constraints based on geology, drilling equipment, temperature, casing limitations, hole sizing, or budget. The planning is also complicated in those cases where the well being planned is one for a known producing reservoir with a number of wells already in place.

The task of planning a new well in a field with a high density of wells, complex geological features, multiple formation targets and advancing flood front or expanding gas cap is extremely challenging. Based on geological information, formation pressure, or fluid data, a suitable subsurface location for planned future drilling is selected. Consideration must be given to distance analysis between the proposed well and existing wells in close proximity. In addition, the proposed well trajectory during drilling through the earth is developed, and information about the nature of the rock layers to be encountered must be taken into account. Further, the drilling bit to be used, the depths in the well for placement or hanging of casing, and the nature and characteristics of the drilling mud are other parameters to be taken into consideration.

Drill bit evaluation is done typically after a general plan for the proposed well is outlined. Historical data about the reservoir, geology and other variables is analyzed. The bit selection is normally also based on drilling parameters from other wells in the reservoir.

Based on well design, drill bits are to be selected. Bits are identified by an industry standard coding system known as an IADC (International Association of Drilling Contractors) code based on bit size, characteristics, and performance. Usually there are several types of bits which are being considered as suitable candidates for the planned well.

Typical practice is for interested vendors or bit suppliers to propose drill bits for the planned well and to provide a predicted cost per foot (CPF) for each proposed bit for the planned well. However, experience shows that CPF data from vendors is often presented in a most favorable light by each vendor. Further, different vendors may be basing their data on different criteria or different suppositions of the drilling conditions thought to be encountered or on data from performance of the bits proposed in wells drilled in different conditions or different rock strata than that to be encountered by the planned well. Also the data from different vendors is usually not in a common or standard form. Vendors were also reluctant to make available information about how their CPF data was determined as well as the criteria used in such determinations.

U.S. Pat. No. 3,752,966 involved a drill bit utilization optimization calculator for use at well sites by those involved in the drilling. The calculator was used for making determinations based on observed changes in drilling conditions. The calculator provided CPF data to indicate when it would be desirable to remove and replace a drill bit then drilling in the wellbore with another bit. The change was indicated by changes in CPF data values based on changes in ongoing drilling operations. As such, a calculator of this type did not lend itself to comparative evaluation of different types of proposed bits submitted for use under planned drilling projects.

So far as is known, there has been no standard analytical method to measure projected bit performance of bits proposed by several vendor sources for use in a planned well. Engineers have been required to spend considerable time analyzing data from the several sources usually in different form to make a decision based one varying predicted results from different bit providers.

### SUMMARY OF THE INVENTION

Briefly, the present invention provides a new and improved computer implemented method of determining a measure of projected drilling cost per foot for a drill bit forming a proposed well with a wellbore for a planned hydrocarbon well through formation rock layers, the computer implemented method. According to the method, data are assembled from a database about the nature and extent of the formation rock to be drilled by the drill bit. Data are also assembled from a database about the proposed well and wellbore for the planned hydrocarbon well, and data assembled from a database about performance characteristics of the drill bit. The projected drilling cost per foot for the drill bit in the planned hydrocarbon well is then determined based on the data assembled from the databases.

The present invention also provides a new and improved data processing system for determining a measure of projected drilling cost per foot for a drill bit forming a proposed well with a wellbore for a planned hydrocarbon well through formation rock layers. The data processing system includes a processor which assembles data from a database about the nature and extent of the formation rock to be drilled by the drill bit. The processor also assembles data from a database about the proposed well and wellbore for the planned hydrocarbon well, and data from a database about performance characteristics of the drill bit. The processor determines the projected drilling cost per foot for the drill bit in the planned hydrocarbon well based on the data assembled from the databases.

The present invention further provides a new and improved data storage device having stored in a non-transitory computer readable medium computer operable instructions for causing a data processing system to determine a measure of projected drilling cost per foot for a drill bit forming a proposed well with a wellbore for a planned hydrocarbon well through formation rock layers. The instructions stored in the data storage device causing the data processing system to assemble data from a database about the nature and extent of the formation rock to be drilled by the drill bit. The instructions also cause the data processing system to assemble data from a database about the proposed well and wellbore for the planned hydrocarbon well, and to assemble data from a database about performance characteristics of the drill bit. The instructions further cause the data processing system to determine the projected drilling cost per foot for the drill bit in the planned hydrocarbon well based on the data assembled from the databases.

### BRIEF DESCRIPTION OF THE DRAWINGS

FIG. 1 is a schematic view, taken in cross-section, of a well and drill string during drilling in the earth through subsurface earth formation layers.

FIG. 2 is a schematic view, taken partly in cross-section, of portions of the structure of FIG. 1.

FIG. 3 a functional block diagram of a flow chart of data processing steps for a method and system for analysis of the performance of drill bits proposed for use in drilling wells according to the present invention.

FIG. 4 is a schematic diagram of a data processing system for analysis of the performance of drill bits proposed for use in drilling wells according to the methodology of FIG. 3.

FIG. 5 is a schematic diagram of a database storing data for processing for analysis of the performance of drill bits proposed for use in drilling wells according to the present invention.

FIGS. 6A and 6B are functional block diagrams of a flow chart of data processing steps for bit performance analysis according to the present invention.

FIGS. 7 and 8 are data output displays formed according to the present invention of the performance of the drill bits.

### DETAILED DESCRIPTION OF THE PREFERRED EMBODIMENTS

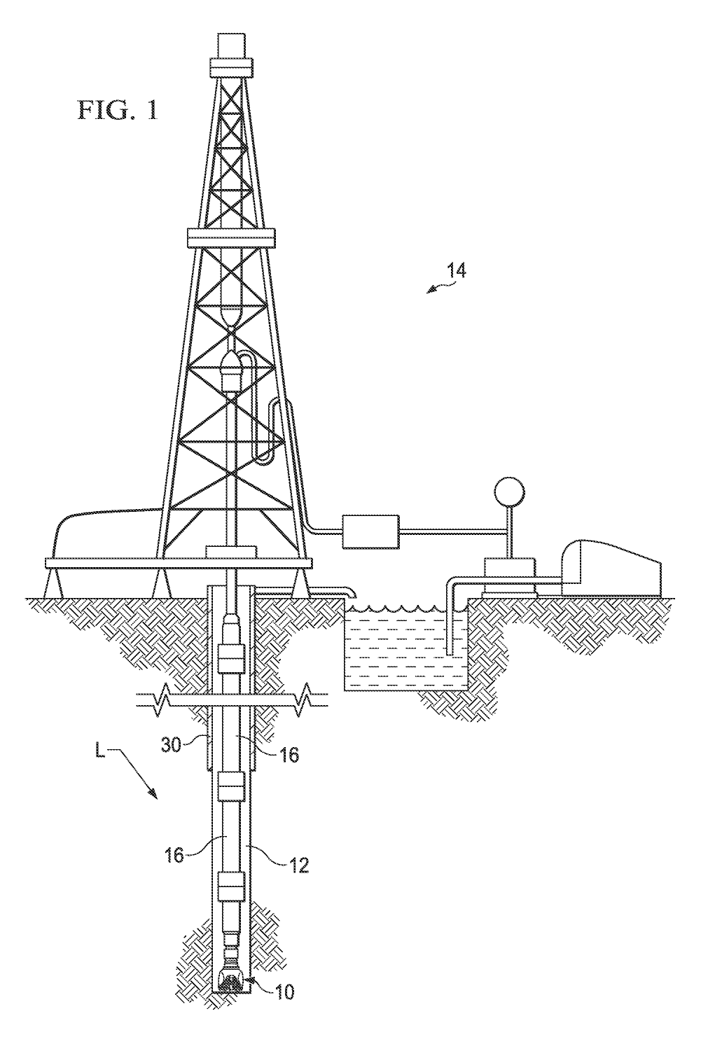

By way of further background, wellbore drilling for petroleum exploration and production, includes a rotating drill bit 10 (FIG. 1) to which an axial force is applied to form a wellbore or borehole 12 extending into subsurface rock layers L. The rotation and the axial force applied to the drill bit 10 are typically provided by surface equipment which includes a drilling rig 14. The rig 14 includes various conventional devices thereon to lift, rotate, and control segments of drill pipe 16 which connect the drill bit 10 to the equipment on the rig 14. The drill pipe 16 includes a hydraulic passage generally in its center through which drilling fluid commonly known as mud is pumped during drilling. The drilling mud discharges through orifices in the bit 10 for cooling the drill bit and lifting rock cuttings out of the wellbore as it is being drilled.

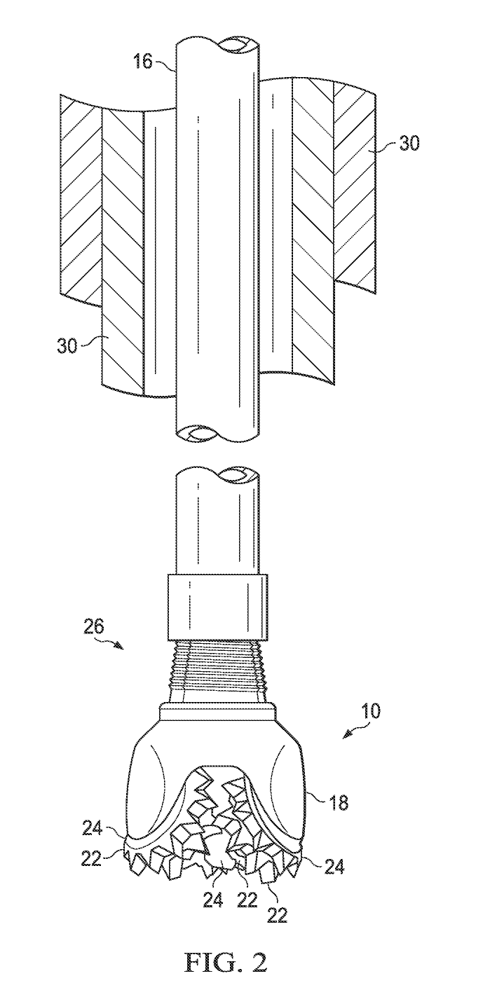

The drill bit 10 is preferably a roller cone-type drill bit, as shown in further detail in FIG. 2. Roller cone bits 10 typically comprise a bit body 18 having an externally threaded connection at one end 20 to the drill pipe 16, and a plurality of roller cones 22 (typically three, as shown) attached to the other end of the bit 10 for rotational movement with respect to the bit body 18. Mounted on the roller cones 22 are a plurality of cutting elements or teeth 24 of suitable strength and cutting capacity typically arranged in rows about the surface of the cones 22. The drill bit 10 and bit body are components of what is known as a bottomhole assembly or BHA 26.

As the wellbore 12 is drilled to a certain planned depth such as at 28, sections of steel pipe or casing 30, slightly smaller in diameter than the borehole 12, are placed in the hole. Concrete may be placed between the outside of the casing 30 and an inner wall of the borehole 12. The casing 30 provides structural integrity to the drilled wellbore 12, in addition to isolating potentially dangerous subsurface high pressure zones from each other and from the surface.

With the zones safely isolated and the formation protected by the casing 30, the wellbore 12 is drilled deeper with a smaller bit, and also cased with a smaller size casing. Modern wells often have two to five sets of subsequently smaller hole sizes drilled to increasing depths inside one another, each cemented with casing. In actual practice, a well penetrates multiple formation layers of differing types of rock (aanhydrite, dolomite, shale, limestone, and sandstone, for example) with different characteristics. This causes wells to have differing drilling strategies, trajectories, and characteristics. Further the type of bit used in certain segments of the drilling may be different from that in others due to the type of rock to be encountered.

The wellbore 12 illustrated in FIG. 1 is illustrated as being generally vertical. It should be understood that the wells for which drill bits are evaluated with the present invention may be vertical as shown in FIG. 1, as well as deviated wells or horizontally drilled or lateral wells, as is becoming a more common practice.

The speed and economy with which a wellbore is drilled, as well as the quality of the hole drilled, thus depend on a number of factors. These factors include, among others, the mechanical properties of the rocks which are drilled, the diameter and type of the drill bit used, the flow rate of the drilling fluid, and the rotation speed and axial force applied to the drill bit. It is generally the case that for any particular mechanical properties of rocks, a rate of penetration at which the drill bit penetrates the rock (“ROP”) corresponds to the amount of axial force on and the rotary speed of the drill bit.

In planning a proposed well common practice is for several vendors or bit providers to provide specifications for one or more bits with bit performance data for the bits proposed including a forecast cost per foot for the bits being offered. The bit performance data from vendors is often optimistic and presented in a most favorable light by each vendor, and in no standard format. Different vendors may be basing their data on different criteria or different suppositions of the drilling conditions thought to be encountered or on data from performance of the bits proposed in wells drilled in different conditions or different rock strata than that to be encountered.

So far as is known, before the present invention, the criteria to calculate the CPF was dependent on the provider or proposed drill bit vendor. The following Table 1 depicts in tabular form estimates of CPF and other bit data from three different vendor companies for five different well runs of different footage and extending between different well depths. Each of the three companies proposed its own CPF estimates for the well runs under its own criteria for the drill bit types being proposed for a well, and the results are assembled and tabulated in the three right columns of Table 1.

TABLE 1

| | | | | | | | | | CPF | | |
|---|---|---|---|---|---|---|---|---|---|---|---|
| | | Bit | Drilling | | | | Depth | Depth | Co | Co | Co |
| Run # | Well | Model | System | ROP | Footage | Hours | In | Out | “A” | “B” | “C” |
| 1 | WELL-AAA | H | RSS | 51.7 | 5271 | 102 | 16179 | 21450 | 39.11 | 44.22 | 44.42 |
| 2 | WELL-BBB | F | RSS | 48.4 | 5004 | 103.5 | 20260 | 25264 | 40.85 | 46.54 | 46.74 |
| 3 | WELL-CCC | H | RSS | 47.7 | 5314 | 111.5 | 18853 | 24167 | 41.92 | 46.77 | 46.84 |
| 4 | WELL-DDD | H | RSS | 42.3 | 5345 | 126.5 | 21680 | 27025 | 46.12 | 50.48 | 50.68 |
| 5 | WELL-EEE | R | RSS | 38.4 | 5820 | 151.5 | 15526 | 21346 | 46.29 | 51.95 | 52.32 |
| Avg. | | | | 45.67 | 5,351 | 119.00 | 18499.60 | 23850.40 | 42.86 | 47.99 | 48.20 |

As can be seen, the CPF data for each of bit runs 1 through 5 are present in the Table, using the same bit model (whether Model H, Model F or Model R). The model designators are used for example purposes rather than proprietary designations actually used by the vendors. The data in the Table for individual ones of the bit runs for the three vendors vary significantly. The CPF figures from different vendors vary in a number of cases by more than ten percent.

The averages shown in Table 1 indicate the significant variations in cost per foot between vendors A, B, and C. In average, the difference in the cost per foot is about 13%. This gives rise to uncertainty during well planning about using data coming from the vendors.

With the present invention, a computer implemented methodology is provided to determine cost per foot (CPF) for drill bits from one or more vendors for a proposed well based on standard processing methodology and common database of historical data from other wells and from similar formations to those at the site of the planned well, as well as performance of the types of drill bits contemplated in similar conditions, as well as projected drilling strategies and trajectories.

The present invention also updates the database to be able to get accurate information, and finally developed the bit performance analyzer according to the present invention. The present invention permits a drilling engineer to select the best bit to be used based on three different criteria: Lower cost per foot, best rate of penetration (ROP), and longest footage, under specific conditions, such as: depth, diameter, inclination, field, kind of well, etc. In addition, the present invention helps to identify expectations to evaluate new proposed bits and to evaluate the results of the trial test runs. The present invention permits drilling engineers and other users a uniform method to measure proposed performance and to unify the Cost per Foot (CPF) determination and not have to depend on CPF estimates from various bit vendors.

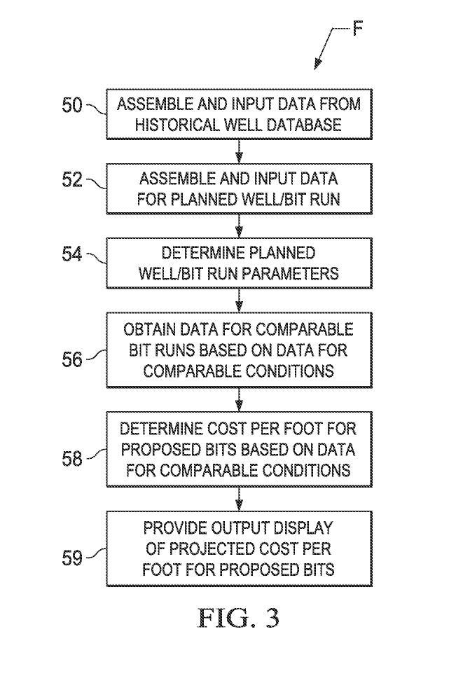

A flow chart F (FIG. 3) illustrates the structure of the logic of the present invention for bit performance analysis as embodied in computer program software. Those skilled in the art will appreciate that the flow charts illustrate the structures of computer program code elements including logic circuits on an integrated circuit that function according to this invention. Manifestly, the invention is practiced in its essential embodiment by a machine component that renders the program code elements in a form that instructs a digital processing apparatus (that is, a computer) to perform a sequence of data transformation or processing steps corresponding to those shown.

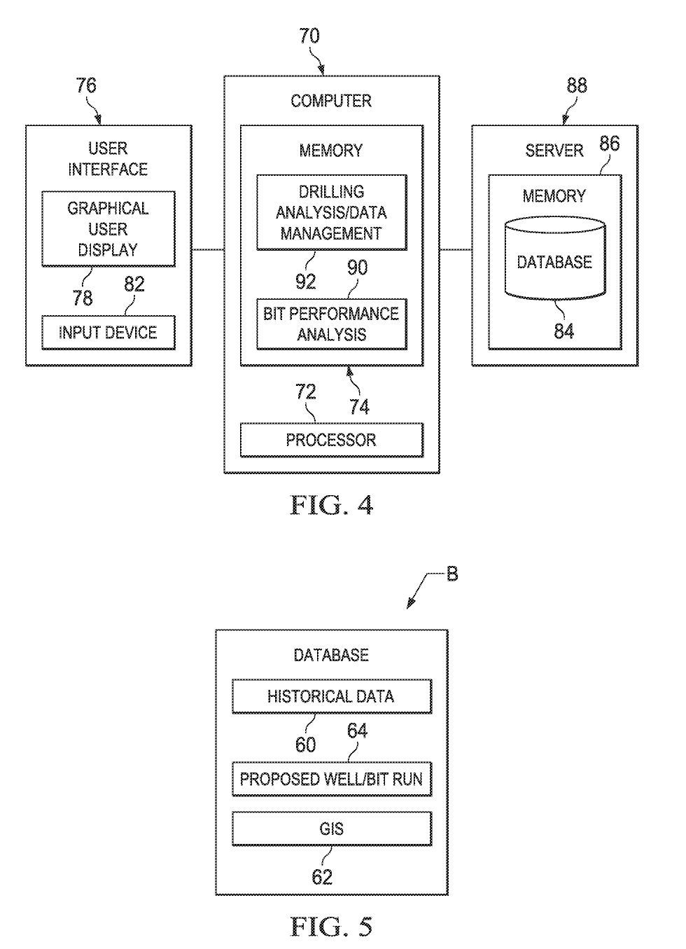

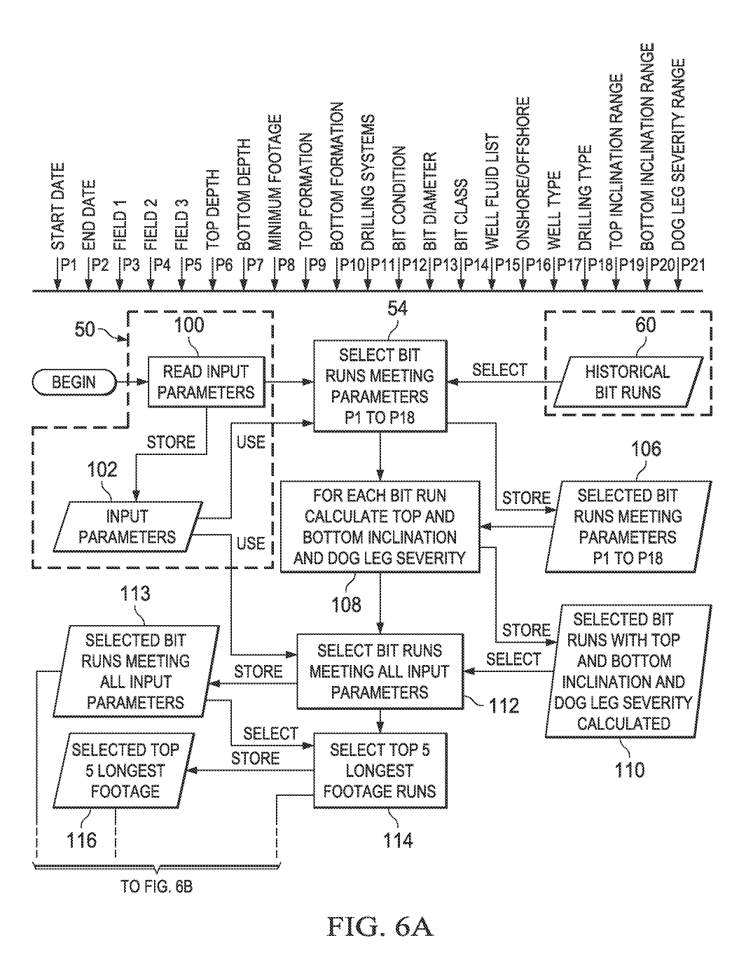

FIG. 3 illustrates schematically a preferred sequence of steps of a process performed by a data processing system D (FIGS. 4 and 5) for analyzing the performance of drill bits proposed for use in drilling wells for comparison and evaluation based on field experience, projected drilling and formation conditions, and performance criteria.

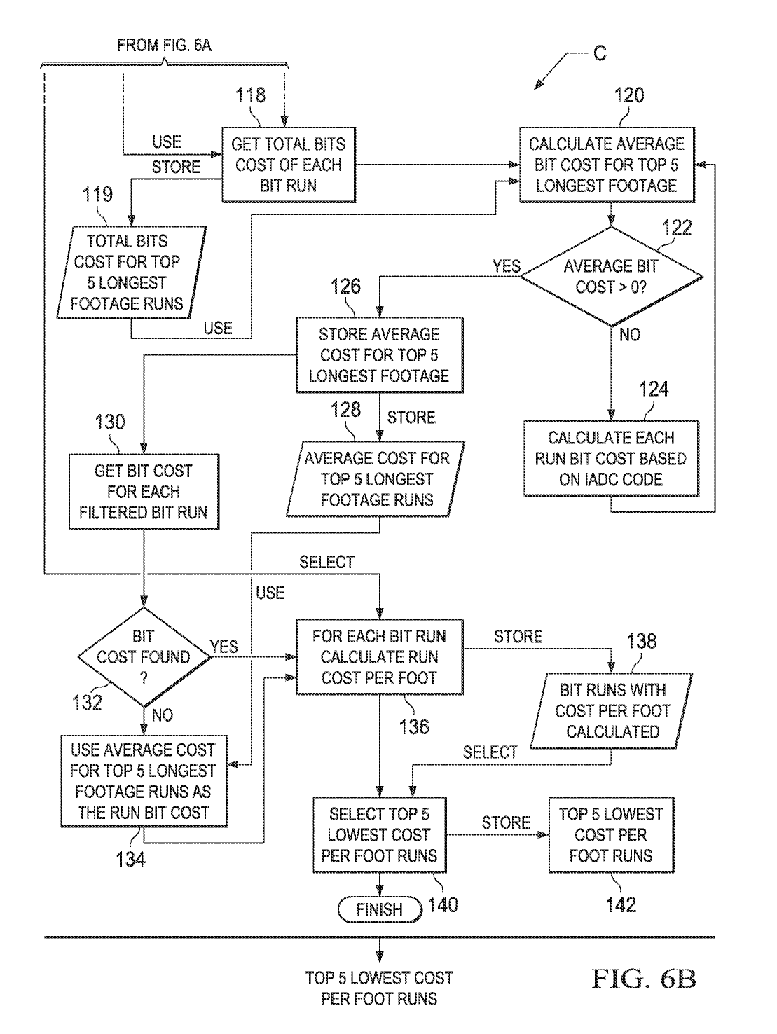

As shown at step 50, processing according to the present invention begins with assembling from a historical well database data 60 from a database B (FIG. 5) from other wells and from similar formations to those at the site of the planned well, as well as performance of the types of drill bits contemplated in similar conditions. The data assembled from the historical database 60 are illustrated as input parameters P1 through P21 in FIGS. 6A and 6B, and includes the following data from wells previously drilled:
Bit run data for bits used in, which includes (field, well name, bit model, bit size, bit serial number, bit IADC code, bit condition, start depth, end depth, drilling system, run date)
Bit cost data for such bits
Per well data which includes (well type, well fluid, trajectory, onshore/offshore, and formations)
Bit inventory accessibility
Bit tracking based on serial number
Bit benchmarking based on bit model
Bit performance analysis for a specific period of time
Casing point to casing point analysis
Drilling data from earlier wells penetrating various types of rocks (anhydrite, dolomite, shale, limestone, and sandstone) with different drilling bits
Inclination at the start point of the drilling run
Inclination of the ending point of the drilling run
Final condition (dull grading) of the bit used

The data assembled during step 50 also includes Geographical Information System map data from a Geographical Information System or GIS database 62 (FIG. 5) which includes the well's location and geographical analysis area selection data used in selecting the well's location.

During step 52, data are assembled from a database 64 (FIG. 5) of planned well or bit run data and provided as inputs for the planned well or drill bit run to be drilled including projected drilling strategies and trajectories, drilling type, well type, bit type, drilling system footage, whether the well is a lateral well, depth in the well where the drilling runs begins, and depth out, where the drilling run ends, rig rate, trip speed, range of inclination of the well to be drilled, Drilling type (New Well/Workover Well), and Well Location (Onshore/Offshore).

During step 54, parameters for the planned well or bit run are determined. During step 56, data from comparable bit runs are obtained from the historical well database. The data supplied during step 50 is analyzed during step 56 and a database fetching is performed in order to obtain comparable historical data from database 60 for bit runs with the same technical characteristics as those developed during step 54 for the well which is being planned.

Using the data from comparable bit runs are obtained from the historical well database 60 during step 56 and the determined parameters for the planned well or bit run from step 54, during step 58 a cost per foot for the proposed bit is determined with the present invention. The determination made during step 58 is based on the following relationship:

$$CPF = \frac{Bit Cost + Rig Rate [ Bit Hours + \frac{Depth Out}{Trip Speed} ]}{footage drilled}$$

The cost per foot determinations of step 58 are performed for each of the bits proposed by vendors for each of the projected bit runs. Then, during step 59, the resulting coast per foot or CPF data is sorted according to the present invention for the different runs, based on cost per foot and the obtained results stored in suitable memory and databases and displayed on request with the data processing system D. The drilling engineer or other user may then analyze the results and select the best runs for the projected well using the cost per foot data obtained for comparison and evaluation based on the same field experience, projected drilling and formation conditions, and actual performance obtained from historical data in comparable conditions.

The historical database 60, GIS database 62 and proposed well/bit run database 64 (FIG. 5) may be stored in a separate file server or servers 88 (FIG. 4) accessible to the data processing system D, or may be stored in other suitable memory of the data processing system D.

As illustrated in FIG. 4, the data processing system D includes a computer 70 having a processor 72 and memory 74 coupled to the processor 72 to store operating instructions, control information and database records therein. The data processing system D may be a multicore processor with nodes such as those from Intel Corporation or Advanced Micro Devices (AMD), an HPC Linux cluster computer or a mainframe computer of any conventional type of suitable processing capacity such as those available from International Business Machines (IBM) of Armonk, N.Y. or other source. The data processing system D may also be a computer of any conventional type of suitable processing capacity, such as a personal computer, laptop computer, or any other suitable processing apparatus. It should thus be understood that a number of commercially available data processing systems and types of computers may be used for this purpose.

The processor 72 is, however, typically in the form of a personal computer having a user interface 76 and an output display 78 for displaying output data or records of processing of bit performance criteria, historical well data and planned well data way to provide cost per foot data according to the present invention. The output display 78 includes components such as a printer and an output display screen capable of providing printed output information or visible displays in the form of graphs, data sheets, graphical images, data plots and the like as output records or images.

The user interface 76 of computer 70 also includes a suitable user input device or input/output control unit 82 to provide a user access to control or access information and database records and operate the computer 70.

The data processing system D includes bit performance analysis program code 90 stored in a data storage device, such as memory 74 of the computer 70. The bit performance analysis program code 90 while operating according to the flow charts F and C operates in conjunction with bit performance analysis/data management program code instructions 94. The bit performance analysis/data management program code instructions 94 also interact with the database B and permit a user to monitor and analyze drilling data and features obtained during previous wells for general purposes, for benchmarking and for trend analysis.

The bit performance analysis/data management program code instructions 94 also permit a user to analyze for trouble of problems during drilling of previous wells and to analyze drilling job performance by various vendors/drilling service providers during earlier wells. The bit performance analysis/data management functionality of program code instructions 94 may, for example, be like that described in comparable portions of the Automatic Drilling Analytics Tool described in Saudi Aramco Journal of Technology, Fall 2013. It should be understood, however, that other drilling analysis/data management functionality may also be used for monitoring, problem analysis and vendor performance, if desired.

The bit performance analysis program code 90 according to the present invention is in the form of computer operable instructions causing the data processor 72 to perform the methodology according to the flow Chart F (FIG. 3) and the flow chart C (FIGS. 6A and 6B) in order to process bit performance criteria, historical well data and planned well data way to provide cost per foot data according to the present invention.

It should be noted that bit performance analysis program code 90 may be in the form of microcode, programs, routines, or symbolic computer operable languages that provide a specific set of ordered operations that control the functioning of the data processing system D and direct its operation. The instructions of bit performance analysis program code 90 may be may be stored in non-transitory memory 74 of the computer 70, or on computer diskette, magnetic tape, conventional hard disk drive, electronic read-only memory, optical storage device, or other appropriate data storage device having a computer usable medium stored thereon. Bit performance analysis program code 90 may also be contained on a data storage device such as server 88 as a non-transitory computer readable medium, as shown.

The processor 72 of the computer 70 accesses the bit performance criteria, historical well data and planned well data way to provide cost per foot data according to the present invention as described above to perform the logic of the present invention, which may be executed by the processor 72 as a series of computer-executable instructions. The stored computer operable instructions cause the data processor computer 70 to access and process the bit performance criteria, historical well data and planned well data to provide cost per foot data according to the present invention in the manner described above and shown in FIG. 3. Results of such processing are then available on output display 78.

Flow chart C (FIGS. 6A and 6B) illustrates in more detail the bit performance analysis processing of the present invention shown at a higher level of functionality in the flow chart F of FIG. 3. Where applicable, the interrelation between the two flow charts and the data processing system D is indicated by like reference numeral in the drawing figures.

As indicated at step 100 in the flow chart C, input parameters for processing as indicated above are read in, and then stored in memory as input parameters as indicated at step 102 as described above for step 50 in flow Chart F.

Step 54 in the flow charts C and F represents the selection of bit runs from the database of historical bit runs stored in historical database 60 which meet the specified input parameters resulting from step 100. Step 106 indicates the storage in proposed well/bit run database 62 of related bit run parameters which during step 54 are determined to meet each of the selected input parameters. Step 108 then causes the data processing system D to calculate or determine Top and Bottom Inclination and Dog Leg Severity of the well in the following manner.

### Inclination

The inclination at any depth is obtained from the actual values stored in the database which are coming from directional surveys. When the inclination at any specific depth is not on the database, a linear interpolation between the two closer records is performed to identify the inclination. To do that the following equation is used:

I=I₁+m*(D−D₁)

### Where:

$$m = \frac{{I}_{2} - {I}_{1}}{{D}_{2} - {D}_{1}}$$

### And,

I=Inclination at depth D
I₁=Inclination at Depth D₁
I₂=Inclination at Depth D₂

### Dog Leg Severity (DLS)

Dog Leg Severity is calculated by using the following equation:

$$DLS = \frac{{I}_{2} - {I}_{1}}{{D}_{2} - {D}_{1}} * 100$$

### Where:

DLS=Dog Leg Severity (°/100 ft)
I₁=Inclination at depth D₁
I₂=Inclination at depth D₂

As indicated, during step 110 bit runs with Top and Bottom Inclination and Dog Leg Severity calculated during step 108 are stored in proposed well/bit run database 62. In step 112, the bit runs selected from the group of previous bit runs which meet the input parameters for the proposed well stored during step 102, as well as having performance parameters which meet each of the input ranges and the determined top inclination ranges, bottom inclination ranges and dogleg severity ranges determined during step 108 are selected. The bit run data for the bit runs selected during step 112 are then stored in proposed well/bit run database 62 during step 113.

Step 114 involves selection of a suitable number of longest footage runs from the bit runs which were chosen during step 112. In the disclosed embodiment, the number chosen is five, although it should be understood that a different number of longest footage runs may be selected, if desired. The longest footage bit runs selected during step 114 are then stored in proposed well/bit run database 62 as indicated at step 116.

Step 118 involves obtaining from the proposed well/bit run database 62 the total bit cost for the drill bits used in the longest bit runs selected during step 116. The total bit cost for the drill bits used in the longest footage runs obtained during step 118 are then stored in proposed well/bit run database 62 during step 119. In step 120, calculations of the average bit cost are made for the five longest footage runs obtained during step 118 and stored during step 119.

During step 122 a determination is made whether the average bit cost determined during step 120 is a positive number. If not, during step 124 a bit cost is calculated for each run based on the cost data according to the IADC code in the following Table.

| IADC Code Start With Letter | Cost ($) |
|---|---|
| M | 45000 |
| S | 55000 |
| Any other letter | 15000 |

The foregoing costs are examples and can be adjusted based on experience. Processing then returns to step 120 and the results obtained during step 124 are used to determine average bit cost based for the five longest footage bit runs.

If during step 122 it is determined that the average bit cost results from step 120 are a positive number, in step 126 the determined average bit cost is then stored in proposed well/bit run database 62, as indicated at step 128, as an average bit cost for the five longest footage runs.

During step 130, the bit cost of each of the five bits used in the filtered runs according to those with the longest footage runs are sought to be located. In step 132 an inquiry is made whether a bit cost has been obtained for each of the filtered bit runs in step 112. If not, during step 134 an average bit cost for those of the five longest footage bit runs for which bit costs are available is determined and used as the average bit cost for subsequent processing.

If step 132 indicates that a bit cost has been obtained for each of the five bits used in the filtered runs, during step 136 a cost per foot is calculated for each of the bit runs used in the filtered runs. Also during step 136, the average cost obtained during step 134 may be used if bit costs for all five longest footage runs are not obtained. In either case, cost per foot is determined in the following manner.

### Cost Per Foot (CPF)

The equation used to calculate the Cost per foot (CPF) depends on the Drilling System used. If the Drilling System is either Conventional, Motor, RSS or RSS+Motor, the following equation is used.

The Cost per foot (CPF) calculation is as follows:

$$CPF = \frac{Bit Cost + Rig Rate [ Bit Hours + \frac{Depth Out}{Trip Speed} ]}{footage drilled}$$

### Where:

Rig rate: $US/hr

### And

| | |
|---|---|
| Onshore | Offshore |

| Drilling System | Gas | Oil | Gas | Oil |
|---|---|---|---|---|
| Conventional | 1670 | 1250 | 7300 | 6100 |
| Motor | 1920 | 1500 | 7550 | 6350 |
| RSS | 2170 | 1750 | 7800 | 6600 |
| RSS + Motor | 2420 | 2000 | 8050 | 6850 |
| Turbine | 2378 | 1958 | 8008 | 6808 |

Trip Speed: 1000 ft/hr
Re-run bit: Zero bit cost

If the Drilling System is Turbine the equation used is the following:

$$CPF = \frac{Bit Cost + Rig Rate * Bit Hours}{footage drilled}$$

To determine the Bit Cost during step 136, first the actual cost paid to the bit provider is obtained from the historic database 60 using the serial number for identification. Then the most recent cost for the same bit model in the same size is obtained. If, during step 122 the actual cost paid for the identified bit cost is lower than the most recent cost, the most recent cost is used. Otherwise, the actual cost is used. If no cost is found, the average cost for top 5 longest footage bit runs will be used (step 134).

During step 138, the resultant CPF calculations for the bit runs from step 136 are stored in proposed well/bit run database 62. During step 140, the five lowest cost per foot runs of those stored as a result of step 138 are selected, and stored in both historical database 60 and proposed well/bit run database 62 as indicated at step 142.

The data stored during step 142 are then available in memory of the data processing system D for use by drilling engineers in well planning and in evaluating drill plans submitted by vendors/drilling service providers. The stored cost per foot data determined in step 136 are also available for display with the user interface 76 of the data processing system D.

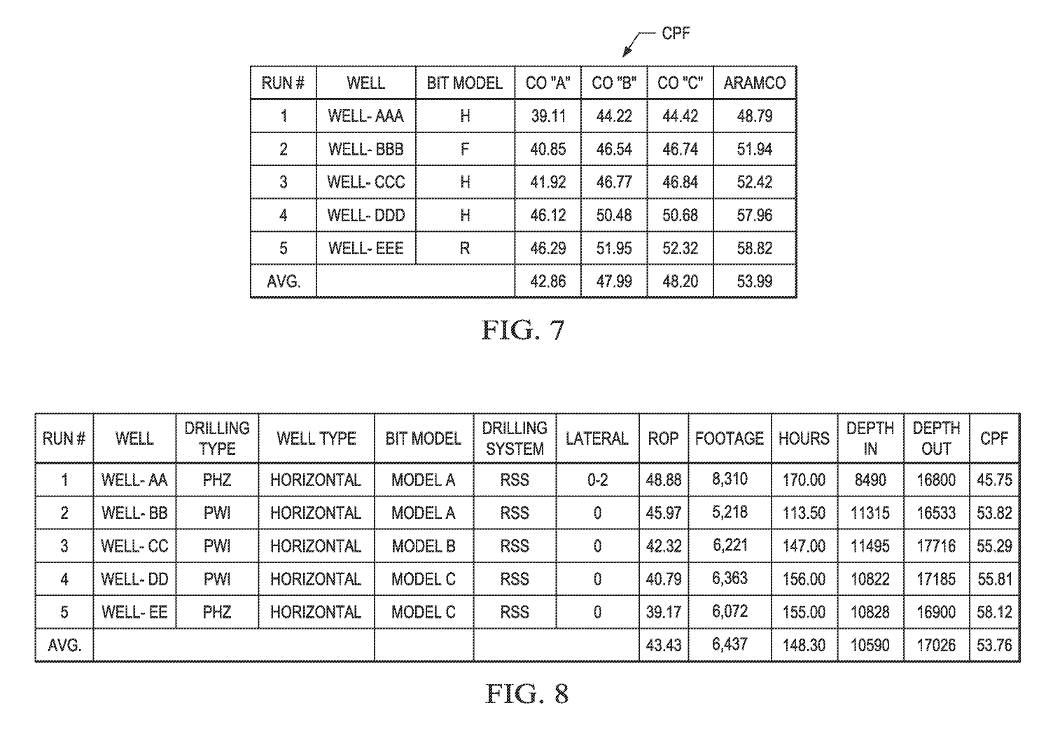

FIGS. 7 and 8 are example displays of such results. FIG. 7 is a comparative tabulation of CPF obtained from vendors as described in Table 1 above with a further column at the right indicating CPF determinations obtained according to the present invention for same bit runs. As can be seen, the vendor supplied CPF figures in each case were underestimates, in many instances being more than ten percent underestimated.

Based on a specific case, another analysis was performed according to the present invention. Applicable data for the example case are as follows:
Field: MNIF (Manifa)
Bit Size: 8.5″
Well Type: Oil Onshore Wells
Projected Drilling Depth: 5000-18000′
Bottom Hole Assembly (BHA) Type: RSS
Type of Bit: New Bits
Projected Borehole Inclination: 37-90+

The results are shown in FIG. 8. Based on the results displayed in FIG. 8 of the analysis performed, the best cost per foot for the conditions of the specific example case is $45.75/ft., which corresponds to the Run of a bit Model A. Based on these results, this would be the recommended bit for the example case.

FIG. 8 also includes the average calculations of the best five runs. These results are stored in memory and made available for use as a benchmarking for a definition of cost per foot expectations when new technology bits are proposed to be evaluated

From the foregoing, it can be seen that the present invention provides the present invention is a complete web application which offers unique features such as a standard way to calculate CPF and generating output reports which include top 5 bit models to be used using different criterions such as cost per foot or CPF, rate of penetration (ROP) and Footage as well as charts for these results. The present invention also offers sensitivity analysis to the drilling system to be used and integration with Geographical Information System to select the analysis area of interest. Moreover, the present invention offers different features such as Casing Point to Casing Point analysis, bit history record, and well record. Combining all of these features to come up with a single result, which is the most efficient drilling bit to be used, in a unique way which proven to save the drilling bit selection time as well as huge cost saving.

With the present invention, drilling engineers are provided with the capability to significantly improve the performance of wells, reducing the cost per foot of drilling wells and also the ability to benchmark criteria for wells with optimum bits to be used under a variety of conditions that may occur under a variety of conditions. From the foregoing, it can be seen that the present invention thus provides an automated, uniform and reliable way to independently determine and evaluate the bit performance of drill bits proposed for wells rather than having to rely on or accept cost per foot data offered from a bit provider or vendor.

The invention has been sufficiently described so that a person with average knowledge in the field of reservoir modeling and simulation may reproduce and obtain the results mentioned in the invention herein. Nonetheless, any skilled person in the field of technique, subject of the invention herein, may carry out modifications not described in the request herein, to apply these modifications to a determined structure and methodology, or in the use and practice thereof, requires the claimed matter in the following claims; such structures and processes shall be covered within the scope of the invention.

It should be noted and understood that there can be improvements and modifications made of the present invention described in detail above without departing from the spirit or scope of the invention as set forth in the accompanying claims.

What is claimed is:

1. A computer implemented method of determining a measure of projected drilling cost per foot for a drill bit forming a proposed well with a wellbore for a planned hydrocarbon well through formation rock layers, the computer implemented method comprising the steps of:
assembling data from a database about the nature and extent of the formation rock to be drilled by the drill bit;
assembling data from a database about the proposed well and wellbore for the planned hydrocarbon well;
assembling data from a database about performance characteristics of the drill bit;
determining the projected drilling cost per foot for the drill bit in the planned hydrocarbon well based on the data assembled from the databases.

2. The computer implemented method of claim 1, wherein the database includes a historical database comprising data about previous wells in formations layers including nature and depth of the formation layers drilled by previous wells, drilling and characteristics of drill bits used in the previous wells, bit run data for the drill bits used in the previous wells, top inclination and bottom inclination ranges of the previous wells, and dog leg severity ranges of the previous wells, and further including the step of:
accessing data in the historical database.

3. The computer implemented method of claim 3, further including the step of:
selecting a group of previous bit runs having performance parameters which meet the input parameters for the proposed well.

4. The computer implemented method of claim 3, further including the step of:
determining top inclination ranges for each of the selected previous bit runs.

5. The computer implemented method of claim 4, further including the step of:
determining bottom inclination ranges for each of the selected previous bit runs.

6. The computer implemented method of claim 5, further including the step of:
determining dog leg severity ranges for each of the selected previous bit runs.

7. The computer implemented method of claim 6, further including the step of:
selecting from the group of previous bit runs having performance parameters which meet the input parameters for the proposed well those wells which meet each of the input ranges and the determined top inclination ranges, bottom inclination ranges and dogleg severity ranges.

8. The computer implemented method of claim 7, further including the step of:
selecting a preset number of bit runs which meet each of the input ranges and the determined top inclination ranges, bottom inclination ranges and dogleg severity ranges which have a longer drill footage run than the remaining wells which meet each of the input ranges and the determined top inclination ranges, bottom inclination ranges and dogleg severity ranges.

9. The computer implemented method of claim 8, further including the step of:
determining an average bit cost for each of the drill bits used in the preset number of bit runs.

10. The computer implemented method of claim 9, further including the step of:
determining an average drilling cost for each of the preset number of bit runs.

11. The computer implemented method of claim 10, wherein the step of determining the projected drilling cost per foot for the drill bit the step of:
determining a bit run cost per foot for each bit run in the selected group of previous bit runs having performance parameters which meet the input parameters for the proposed well based on the determined average drilling cost for each of the preset number of bit runs.

12. The computer implemented method of claim 1, wherein the step of further including the step of:
providing an output display of the determined projected drilling cost per foot for the drill bit in the planned hydrocarbon well.

13. A data processing system for determining a measure of projected drilling cost per foot for a drill bit forming a proposed well with a wellbore for a planned hydrocarbon well through formation rock layers, the data processing system comprising:
a processor performing the steps of:
assembling data from a database about the nature and extent of the formation rock to be drilled by the drill bit;
assembling data from a database about the proposed well and wellbore for the planned hydrocarbon well;
assembling data from a database about performance characteristics of the drill bit;
determining the projected drilling cost per foot for the drill bit in the planned hydrocarbon well based on the data assembled from the databases.

14. The data processing system of claim 13, wherein the database includes a historical database comprising data about previous wells in formations layers including nature and depth of the formation layers drilled by previous wells, drilling and characteristics of drill bits used in the previous wells, bit run data for the drill bits used in the previous wells, top inclination and bottom inclination ranges of the previous wells, and dog leg severity ranges of the previous wells, and the processor further performs the step of:
accessing data in the historical database.

15. The data processing system of claim 14, further including the processor performing the step of:
selecting a group of previous bit runs having performance parameters which meet the input parameters for the proposed well.

16. The data processing system of claim 15, further including the processor performing the step of:
determining top inclination ranges for each of the selected previous bit runs.

17. The data processing system of claim 16, further including the processor performing the step of:
determining bottom inclination ranges for each of the selected previous bit runs.

18. The data processing system of claim 17, further including the processor performing the step of:
determining dog leg severity ranges for each of the selected previous bit runs.

19. The data processing system of claim 18, further including the processor performing the step of:
selecting from the group of previous bit runs having performance parameters which meet the input parameters for the proposed well those wells which meet each of the input ranges and the determined top inclination ranges, bottom inclination ranges and dogleg severity ranges.

20. The data processing system of claim 19, further including the processor performing the step of:
selecting a preset number of bit runs which meet each of the input ranges and the determined top inclination ranges, bottom inclination ranges and dogleg severity ranges which have a longer drill footage run than the remaining wells which meet each of the input ranges and the determined top inclination ranges, bottom inclination ranges and dogleg severity ranges.

21. The data processing system of claim 20, further including the processor performing the step of:
determining an average bit cost for each of the drill bits used in the preset number of bit runs.

22. The data processing system of claim 21, further including the processor performing the step of:
determining an average drilling cost for each of the preset number of bit runs.

23. The data processing system of claim 22, wherein processor in performing the step of determining the projected drilling cost per foot for the drill bit performs the step of:
determining a bit run cost per foot for each bit run in the selected group of previous bit runs having performance parameters which meet the input parameters for the proposed well based on the determined average drilling cost for each of the preset number of bit runs.

24. The data processing system of claim 23, further including:
a user interface providing an output display of the determined projected drilling cost per foot for the drill bit in the planned hydrocarbon well.

25. A data storage device having stored in a non-transitory computer readable medium computer operable instructions for causing a data processing system to determine a measure of projected drilling cost per foot for a drill bit forming a proposed well with a wellbore for a planned hydrocarbon well through formation rock layers, the instructions stored in the data storage device causing the data processing system to perform the following steps:
assembling data from a database about the nature and extent of the formation rock to be drilled by the drill bit;
assembling data from a database about the proposed well and wellbore for the planned hydrocarbon well;
assembling data from a database about performance characteristics of the drill bit;
determining the projected drilling cost per foot for the drill bit in the planned hydrocarbon well based on the data assembled from the databases.

26. The data storage device of claim 25, wherein the database includes a historical database comprising data about previous wells in formations layers including nature and depth of the formation layers drilled by previous wells, drilling and characteristics of drill bits used in the previous wells, bit run data for the drill bits used in the previous wells, top inclination and bottom inclination ranges of the previous wells, and dog leg severity ranges of the previous wells, and wherein the stored instructions cause the data processing system to perform the step of:
accessing data in the historical database.

27. The data storage device of claim 26 wherein the stored instructions cause the data processing system to further perform the step of:
selecting a group of previous bit runs having performance parameters which meet the input parameters for the proposed well.

28. The data storage device of claim 27 wherein the stored instructions cause the data processing system to further perform the step of:
determining top inclination ranges for each of the selected previous bit runs.

29. The data storage device of claim 28 wherein the stored instructions cause the data processing system to further perform the step of:
determining bottom inclination ranges for each of the selected previous bit runs.

30. The data storage device of claim 29 wherein the stored instructions cause the data processing system to further perform the step of:
determining dog leg severity ranges for each of the selected previous bit runs.

31. The data storage device of claim 30 wherein the stored instructions cause the data processing system to further perform the step of:
selecting from the group of previous bit runs having performance parameters which meet the input parameters for the proposed well those wells which meet each of the input ranges and the determined top inclination ranges, bottom inclination ranges and dogleg severity ranges.

32. The data storage device of claim 31 wherein the stored instructions cause the data processing system to further perform the step of:
selecting a preset number of bit runs which meet each of the input ranges and the determined top inclination ranges, bottom inclination ranges and dogleg severity ranges which have a longer drill footage run than the remaining wells which meet each of the input ranges and the determined top inclination ranges, bottom inclination ranges and dogleg severity ranges.

33. The data storage device of claim 32 wherein the stored instructions cause the data processing system to further perform the step of:
determining an average bit cost for each of the drill bits used in the preset number of bit runs.

34. The data storage device of claim 33 wherein the stored instructions cause the data processing system to further perform the step of:
determining an average drilling cost for each of the preset number of bit runs.

35. The data storage device of claim 34 wherein the stored instructions cause the data processing system in performing the step of determining the projected drilling cost per foot for the drill bit to further perform the step of:
determining a bit run cost per foot for each bit run in the selected group of previous bit runs having performance parameters which meet the input parameters for the proposed well based on the determined average drilling cost for each of the preset number of bit runs.

36. The data storage devices further including instructions causing the data processing system to perform the step of:
providing an output display of the determined projected drilling cost per foot for the drill bit in the planned hydrocarbon well.
